(19) United States
(12) Patent Application Publication
(10) Pub. No.: US 2015/0291138 A1
(43) Pub. Date: Oct. 15, 2015

(54) INCREASED VEHICLE BRAKING GRADIENT

(71) Applicant: FORD GLOBAL TECHNOLOGIES, LLC, Dearborn, MI (US)

(72) Inventor: John P. Joyce, West Boomfield, MI (US)

(73) Assignee: FORD GLOBAL TECHNOLOGIES, LLC, Dearborn, MI (US)

(21) Appl. No.: 14/252,115

(22) Filed: Apr. 14, 2014

(51) Int. Cl. B60T 8/1763; B60L 7/18; B60T 15/02; B60T 8/1761

(52) U.S. Cl. CPC B60T 8/17636; B60T 8/17616; B60L 7/18; B60T 15/028

(57) ABSTRACT

Exemplary illustrations of a method are disclosed, including determining a baseline gradient and an increased gradient for a brake application force for a vehicle. Exemplary methods may further include actuating the baseline gradient in response to a first braking event for the vehicle, and actuating the increased gradient in response to a second braking event for the vehicle. Exemplary illustrations of a vehicle may include a braking system configured to apply braking force to at least one wheel of the vehicle, and a controller. The controller may be configured to determine a baseline gradient and an increased gradient for a brake application force for a vehicle. The controller may be configured to actuate the baseline gradient in response to a first braking event for the vehicle, and actuate the increased gradient in response to a second braking event for the vehicle.

### BACKGROUND

Vehicles equipped with antilock braking systems are generally designed to apply as much braking force as possible while also preventing excess tire slip. Excessive braking force application will reduce directional control and may reduce applied stopping power if too much tire slip is created, e.g., if braking force is increased too quickly during a braking event. Accordingly, braking systems are typically designed with vehicle traction limits in mind. More specifically, a restriction in the braking system which creates stopping force at the wheel is typically designed to create a maximum stopping force during ideal conditions, e.g., on dry, high-friction surfaces, while not creating excessive slip during non-ideal stopping conditions, e.g., on icy or slippery surfaces.

Braking systems therefore generally must sacrifice maximum stopping power to prevent excessive slip from being created during certain non-ideal stopping conditions. This negatively affects stopping performance during most common braking performance tests, many of which are run during ideal conditions, i.e., on dry, high-friction surfaces. As these tests have become more prevalent and important to consumers, desire to increase performance has increased, however this has not been possible due to the tradeoff with vehicle performance during non-ideal or slippery conditions.

Accordingly, there is a need for improved vehicle braking performance on high-friction surfaces that does not sacrifice performance on non-ideal or low-friction surfaces.

### SUMMARY

Various exemplary illustrations described herein are directed to a method, including determining a baseline gradient and an increased gradient for a brake application force for a vehicle. Exemplary methods may further include actuating the baseline gradient in response to a first braking event for the vehicle, and actuating the increased gradient in response to a second braking event for the vehicle.

Exemplary illustrations are also directed to vehicle comprising a braking system configured to apply braking force to at least one wheel of the vehicle, and a controller. The controller may be configured to determine a baseline gradient and an increased gradient for a brake application force for a vehicle. The controller may be configured to actuate the baseline gradient in response to a first braking event for the vehicle, and actuate the increased gradient in response to a second braking event for the vehicle.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

FIG. 1 is a schematic view of an exemplary hydraulic braking system for a vehicle, according to an exemplary illustration;

FIG. 2 is a schematic view of an exemplary braking system for a vehicle using an integrated boost/brake control system, according to another exemplary illustration;

FIG. 3 is a schematic view of an exemplary braking system for a vehicle which employs a braking-by-wire system, according to another exemplary illustration;

FIG. 4 is a schematic view of an exemplary braking system for a vehicle using a regenerative braking control system, according to another exemplary illustration; and

FIG. 5 is a process flow diagram for an exemplary method of determining whether a baseline or increased braking gradient is employed for a given braking event for a vehicle.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

As noted above, some exemplary illustrations are directed to a method, which may include determining a baseline gradient and an increased gradient for a brake application force for a vehicle. Exemplary methods may further include actuating the baseline gradient in response to a first braking event for the vehicle, and actuating the increased gradient in response to a second braking event for the vehicle.

In some exemplary approaches, a method may include determining whether an increased brake force application gradient is likely to result in a deep slip condition of an associated tire of the vehicle. These examples may generally actuate the baseline or increased gradient during a braking event based when the increased gradient is determined to be likely or not likely to result in a deep slip condition of the associated tire, respectively.

Exemplary illustrations are also directed to vehicle comprising a braking system configured to apply braking force to at least one wheel of the vehicle, and a controller. The controller may be configured to determine a baseline gradient and an increased gradient for a brake application force for a vehicle. The controller may be configured to actuate the baseline gradient in response to a first braking event for the vehicle, and actuate the increased gradient in response to a second braking event for the vehicle.

Generally, braking gradients as discussed herein may be a rate of a brake force increase associated with an associated tire. Accordingly, an “increased” gradient is generally a rate of the brake force increase associated with the associated tire that is greater than that for a “baseline” gradient. In other examples, braking gradients relate to a rate of change of one a brake pressure, e.g., in a hydraulic braking system, or a brake clamp-force, or a brake torque applied to a vehicle wheel.

Braking gradients may be adjusted in a variety of exemplary braking systems, including hydraulic, pneumatic, electrically activated, or regenerative braking systems, merely as examples. In a hydraulic or pneumatic system, an exemplary gradient may be a brake pressure gradient or rate of pressure increase applied by the system. The varying gradients ultimately may result in different rates of increase of a braking clamp force. Accordingly, in systems not employing hydraulic fluid such as electrically activated brakes or “dry brake-by-wire” systems, exemplary gradients may simply be a brake-force clamp gradient or rate of change associated with a clamping brake force. Such systems have been employed in the context of rear vehicle brakes or trailer braking systems, for example. Another exemplary illustration of a gradient may be a brake torque gradient, or rate of change in braking torque applied by the braking system. This exemplar illustration may be more general than the brake pressure or brake force examples discussed above, but may apply to regenerative braking systems, such as those employed on hybrid or electric vehicles where the brake torque may be generated by an electric motor in the powertrain.

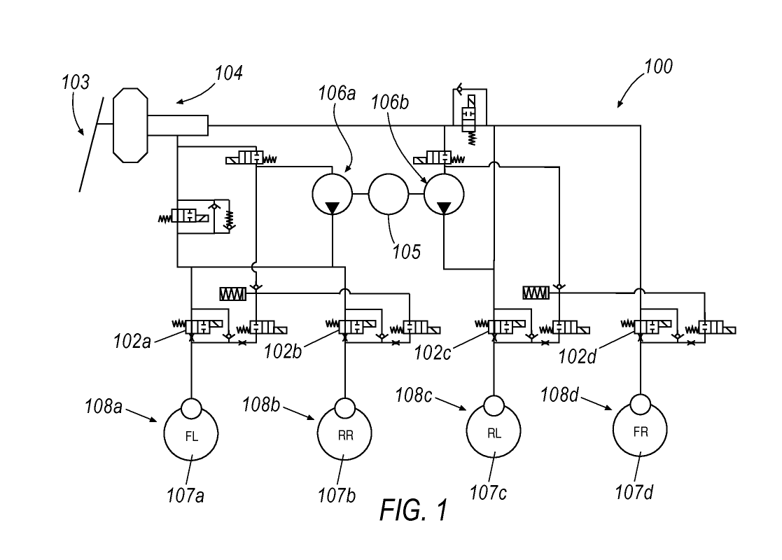

Turning now to FIGS. 1-4, various exemplary braking systems for a vehicle are disclosed. Moreover, any other braking system may be employed that is convenient. Referring now to FIG. 1, an exemplary braking system 100 employing a hydraulic braking control is illustrated. System 100 includes a brake booster 104 receiving fluid from a reservoir 103. The brake booster 104 may be in fluid communication with one or more pressure cylinders 106a, 106b (collectively, 106) configured to supply hydraulic pressure to a plurality of brakes 108a, 108b, 108c, and 108d (collectively, 108), thereby providing hydraulic braking control of a plurality of wheels 107. For example, the pressure cylinders 106 may each receive pressure from a master cylinder 105. In one exemplary approach, a corresponding plurality of valves 102a, 102b, 102c, and 102d (collectively, 102) may generally control hydraulic pressure provided to the brakes 108a, 108b, 108c, and 108d. The valves 102 and/or other components of the system 100 may be in communication with a processor configured to selectively adjust braking force applied to the wheels 107. Accordingly, the valves 102 may each selectively adjust a brake pressure, a clamp force, and a brake torque applied to the wheels 107.

In one exemplary illustration, a braking gradient applied to the brakes 108 may be adjusted by way of the valves 102. For example, the valves 102 may each have a variable orifice having an adjustable setting for braking force, including a first orifice position that is less restrictive than a second orifice position. In one example, a variable size orifice may be used to selectively vary a restriction of the valve 102. Accordingly, the valves 102 may be configured to provide a varying level of hydraulic braking power between a maximum magnitude associated with the valve 102, and a lesser magnitude. As will be described further below, lesser magnitude may correspond to a baseline braking gradient that may be employed in most ordinary vehicle operating conditions. However, in certain conditions it may be advantageous to employ an increased gradient corresponding to the maximum magnitude associated with the valve 102.

In another exemplary approach, a braking gradient may be selectively applied in the system 100 using a “controlled boost” methodology. More specifically, alternatively or in addition to braking gradient adjustments by the valves 102, a braking gradient may be adjusted by selectively adjusting pressure in the brake booster 104.

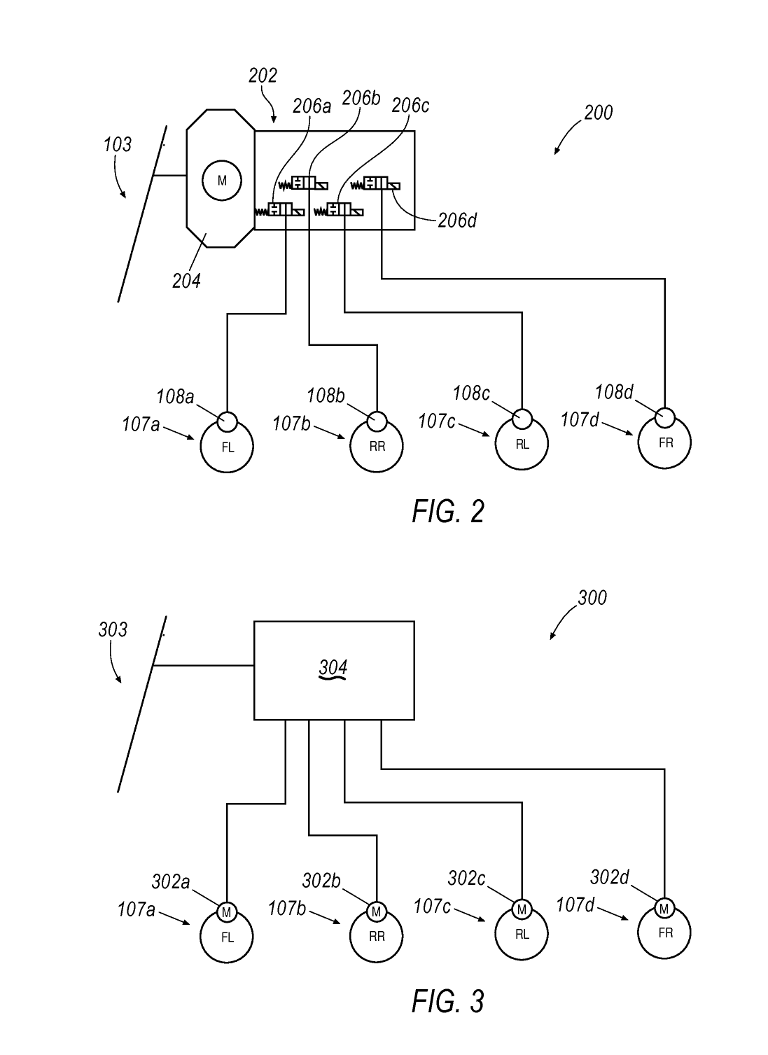

Proceeding to FIG. 2, another exemplary braking system 200 is illustrated that employs an integrated boost/brake control system. More specifically, a plurality of valves 206a, 206b, 206c, 206d (collectively, 206) are incorporated into a brake booster assembly 202. Each of the valves 206 generally modulate or control pressure supplied to from the brake booster 204, which is incorporated into the brake booster assembly 202. The valves 206 may thereby adjust hydraulic pressure supplied to respective brakes 108, thereby controlling braking force applied to the wheels 108. Accordingly, a braking gradient may be selectively adjusted, e.g., to allow more rapid increase of braking force to the wheels 108 under certain operating conditions.

In still another exemplary illustration shown in FIG. 3, a brake-by-wire system 300 is illustrated. In the system 300, braking force is applied to the wheels 107 by corresponding brakes 302a, 302b, 302c, 302d (collectively, 302). The brakes 302 each receive electrical power from a controller 304, which receives power from a power source 303. The power source 303 may include a vehicle electrical system and/or components thereof, e.g., a vehicle battery, alternator, or the like. A braking gradient associated with application of the brakes 302 to the wheels 107 may be varied by the controller 304. Accordingly, a rate of change in brake clamp force or brake torque may be selectively varied under certain operating conditions, as described further below.

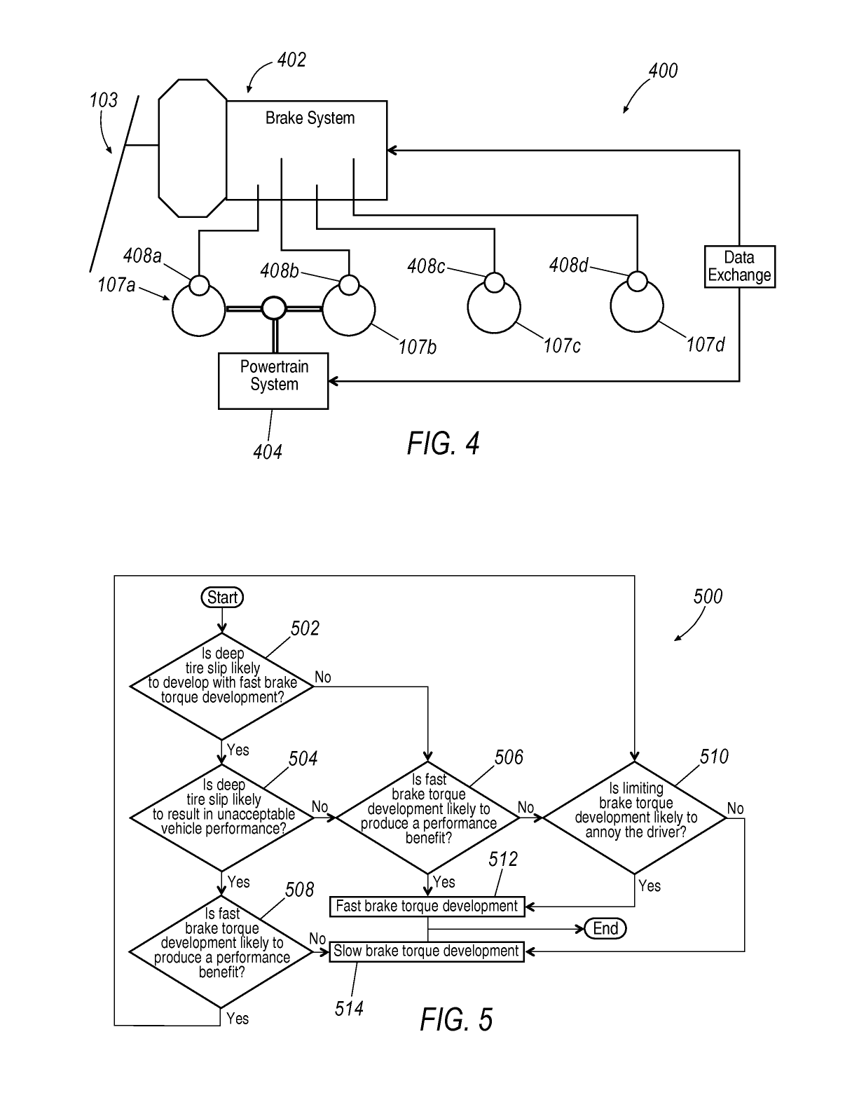

Turning now to FIG. 4, a regenerative braking control system 400 is illustrated. The system 400 may be similar to other systems above regarding application of braking force to a plurality of wheels 107, but further includes a powertrain system 404 configured to apply regenerative braking force to the wheels 107 via corresponding brakes 408a, 408b, 408c, 408d (collectively, 408). For example, the system 400 may include a power source 103 and brake booster 402, which provide braking power to the brakes 408, e.g., via electrical power. Moreover, the powertrain system 404 may also selectively apply braking force, e.g., by applying regenerative braking via the brakes 408. A braking gradient may be selectively altered to apply varying rates of change in a braking force or torque applied to the wheels 107, as will be further described below.

Turning now to FIG. 5, an exemplary process 500 of adjusting a braking gradient for a vehicle is illustrated. The process 500 may generally facilitate determination of whether application of a baseline or normal braking gradient is appropriate, or whether an increased braking gradient may be employed. Accordingly, for different braking events, a vehicle may use different braking gradients to facilitate application of an additional or heightened gradient, i.e., a more rapid brake force increase, when certain operating conditions are present.

Process 500 generally provides an exemplary framework for applying various factors to determine whether a baseline gradient or an increased braking gradient is appropriate for a given braking event. Moreover, while certain exemplary factors are discussed, any number of other factors may be used. Process 500 may generally include factors for determining whether a deep tire slip condition is likely to result from application of an increased braking gradient, whether unacceptable or improved performance would result from using the increased braking gradient, and whether use of the increased or baseline gradient may be perceived by the driver or other vehicle occupants, e.g., as an annoyance. However, any number of other determinations may be used in deciding whether an increased or baseline braking gradient may be employed.

Exemplary illustrations below include factors relating to the above considerations, and thus may be useful in determining whether deep tire slip is likely in response to application of an increased braking gradient, whether deep tire slip is likely to result in unacceptable performance, whether deep tire slip is likely to produce a performance benefit, and whether limiting brake torque development, i.e., applying a baseline or reduced braking gradient, is likely to annoy a vehicle driver. While these examples are provided below, other factors may be used as alternatives or in addition to the specific factors discussed below.

Process 500 may begin at block 502, where it is determined whether a deep tire slip condition is likely to result from using an increased braking gradient. Exemplary illustrations of factors that may increase likelihood of deep tire slip developing in response to application of an increased braking gradient may include ambient temperature, recent road surface friction estimates (based, e.g., upon braking system performance), recent antilock braking control activity, recent fraction control activity, recent peak vehicle deceleration, and recent peak vehicle acceleration.

Exemplary illustrations of factors that may increase likelihood of deep tire slip resulting in unacceptable vehicle performance may include indications of vehicle turning, e.g., as measured by steering wheel angle, yaw rate, or lateral acceleration. In such cases, it may not be desirable to risk deep tire slip if the vehicle is turning or attempting to turn, in which case deep tire slip might be more likely to result in loss of control of the vehicle. Additionally, if vehicle speed is elevated above a certain threshold, e.g., at highway speeds, deep tire slip may be especially undesirable since it may be more likely to cause loss of vehicle control. If deep tire slip is likely, process 500 may proceed to block 504, whereas if deep tire slip is not likely, process 500 may proceed to block 506.

At block 504, process 500 may query whether the deep tire slip determined at block 502 is likely to result in unacceptable vehicle performance. For example, if deep tire slip would be likely to result in a loss of control of the vehicle, e.g., if the vehicle is in a turn, then process 500 may determine that such performance would be unacceptable. Factors that may be used to determine whether a loss of control or other unacceptable performance is likely may include, but are not limited to, steering wheel angle, vehicle yaw rate, vehicle speed, and vehicle lateral acceleration. If process 500 determines that the deep tire slip is likely to result in unacceptable performance, process 500 may proceed to block 508. Alternatively, if deep tire slip is not likely to result in unacceptable performance, process 500 may proceed to block 506.

At block 506 and also at block 508, process 500 may query whether the enhanced or increased braking gradient is likely to result in a performance benefit. Exemplary illustrations of factors that may increase likelihood of the increased braking gradient resulting in a performance benefit may include indications of any known high-value conditions such as, merely as examples, the proximity of an object the vehicle could potentially strike as detected by vehicle systems such as radar, camera, or car-to-car communication. Additionally, the increased braking gradient may be more likely to result in a performance benefit if vehicle speed or other conditions match consumer tests or other benchmark performance tests. In such cases, deep tire slip may be desirable in view of the potential benefits, e.g., of avoiding a collision with a vehicle or pedestrian, or establishing an improved performance test benchmark, e.g., a reduced stopping distance from a given vehicle speed. From block 506, process 500 may proceed to block 512 if it is determined that the increased braking gradient is likely to produce a performance benefit. Alternatively, if at block 506 process 500 determines that the increased braking gradient is not likely to produce a performance benefit, process 500 may proceed to block 510. Additionally, from block 508, process 500 may proceed to block 510 if it is determined that the increased braking gradient is likely to produce a performance benefit. Alternatively, if at block 508 process 500 determines that the increased braking gradient is not likely to produce a performance benefit, process 500 may proceed to block 514.

At block 510, process 510 may determine whether limiting brake force application, e.g., by using the baseline or lesser braking gradient, is likely to be perceived negatively, e.g., by the vehicle driver. Exemplary illustrations of factors that may increase likelihood of a reduced braking gradient annoying a driver or otherwise being perceived negatively may include situations where the driver is actively engaged with or likely to be attentive to braking system feedback, which may be more likely when using a reduced braking gradient. For example, if a driver's foot is on the brake pedal or interior noise level is low, a driver may be more sensitive to changes to an applied braking gradient, since such changes may result in feedback through the brake pedal, and may also be audibly heard by the driver. The driver may also be more attentive to changes in braking gradient where the braking system in which the braking gradient is being applied involves mechanical elements, e.g., a valve, that may suffer from vibration or other telltale reactions to a change in braking gradient. If process 500 determines that limiting brake force application, e.g., by using the baseline or lesser braking gradient, is likely to be perceived negatively, then process 500 may proceed to block 512. Alternatively, if limiting brake force application by using the baseline or lesser braking gradient is not likely to be perceived negatively, then process 500 may proceed to block 514.

At block 512, process 500 may activate the increased braking gradient. As illustrated in FIG. 5, process 500 may reach this result in response to a positive query result at block 506 or block 510.

At block 514, process 500 may activate the baseline or lesser braking gradient. As illustrated in FIG. 5, process 500 may reach this result in response to a negative query result at block 508 or at block 510.

Process 500 may terminate following either block 512 or 514.

Process 500 may run generally constantly with respect to vehicle operation, such that the vehicle may vary between using the baseline braking gradient and the increased braking gradient. In this manner, brake torque, brake pressure, and/or brake force development may be altered for different braking events. Accordingly, a vehicle may generally employ the baseline or reduced braking gradient as a general rule, while selectively employing the increased braking gradient when certain conditions are satisfied, e.g., as described above in regard to process 500.

In some exemplary approaches, the exemplary methods described herein may employ a computer or a computer readable storage medium implementing the various methods and processes described herein, e.g., process 500. In general, computing systems and/or devices, such as the processor and the user input device, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The exemplary illustrations are not limited to the previously described examples. Rather, a plurality of variants and modifications are possible, which also make use of the ideas of the exemplary illustrations and therefore fall within the protective scope. Accordingly, it is to be understood that the above description is intended to be illustrative and not restrictive.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “the,” etc. should be read to recite one or more of the indicated elements unless a claim recites an explicit limitation to the contrary.

What is claimed, is:

1. A method, comprising:
determining a baseline gradient and an increased gradient for a brake application force for a vehicle wheel;
actuating the baseline gradient in response to a first braking event for the vehicle; and
actuating the increased gradient in response to a second braking event for the vehicle;
wherein the baseline and increased gradients include a rate of change of one of a brake pressure, a brake clamp-force, and a brake torque.

2. The method of claim 1, further comprising determining whether the increased brake force application gradient is likely to result in a deep slip condition of an associated tire.

3. The method of claim 2, wherein actuating the baseline gradient includes determining that the increased gradient is likely to result in a deep slip condition of the associated tire.

4. The method of claim 2, wherein actuating the increased gradient includes determining that the increased gradient is not likely to result in a deep slip condition of the associated tire.

5. The method of claim 1, wherein the baseline gradient is a rate of a brake force increase associated with an associated tire.

6. The method of claim 5, wherein the increased gradient is a rate of the brake force increase associated with the associated tire, the increased gradient having a greater rate of the brake force increase over time compared with the baseline gradient.

7. The method of claim 1, wherein actuating the baseline gradient includes selectively restricting a hydraulic system associated with the vehicle with an orifice defining a variable opening, the variable orifice corresponding to the baseline and increased gradients.

8. The method of claim 1, wherein the baseline and increased gradients include a rate of change of the brake torque applied to the vehicle wheel; and further comprising controlling the rate of change of the the brake torque applied to the wheel by controlling one of:
the rate of change of the brake pressure of a brake at the vehicle wheel;
the rate of change of the brake clamp-force of the brake at the wheel; and
the rate of change of a powertrain brake torque at the wheel.

9. The method of claim 1, further comprising selecting only one of the baseline gradient and the increased gradient based upon at least one of a steering wheel angle, an ambient temperature, a vehicle yaw rate, a vehicle lateral acceleration, a determination of recent control system activity of the vehicle wheel, and a received indication of a reduced road surface friction.

10. The method of claim 1, further comprising selecting only one of the baseline gradient and the increased gradient based upon a likelihood of driver disturbance.

11. The method of claim 1, further comprising selecting only one of the baseline gradient and the increased gradient based upon a likelihood of influencing vehicle performance.

12. A method, comprising:
determining a baseline gradient and an increased gradient for a brake application force for a vehicle wheel;
determining whether the increased brake force application gradient is likely to result in a deep slip condition of an associated tire of the vehicle wheel;
actuating the baseline gradient in response to a first braking event for the vehicle in response to a determination that the increased gradient is likely to result in a deep slip condition of the associated tire; and
actuating the increased gradient in response to a second braking event for the vehicle in response to a determination that the increased gradient is not likely to result in a deep slip condition of the associated tire;
wherein the baseline gradient is a rate of a brake force increase associated with the associated tire; and
wherein the increased gradient is a rate of the brake force increase associated with the associated tire, the increased gradient having a greater rate of the brake force increase over time compared with the baseline gradient.

13. The method of claim 12, wherein the baseline and increased gradients include a rate of change of one of a brake pressure, a brake clamp-force, and a brake torque.

14. A vehicle, comprising:
a braking system configured to apply braking force to at least one wheel of the vehicle;
a controller configured to determine a baseline gradient and an increased gradient for a brake application force for a vehicle, the controller configured to actuate the baseline gradient in response to a first braking event for the vehicle, the controller configured to actuate the increased gradient in response to a second braking event for the vehicle, wherein the baseline and increased gradients include a rate of change of one of a brake pressure, a brake clamp-force, and a brake torque.

15. The vehicle of claim 14, wherein the controller is configured to determine whether the increased brake force application gradient is likely to result in a deep slip condition of an associated tire.

16. The vehicle of claim 14, wherein the baseline gradient is a rate of a brake force increase associated with an associated tire, and the increased gradient is a rate of the brake force increase associated with the associated tire, the increased gradient having a greater rate of the brake force increase over time compared with the baseline gradient.

17. The vehicle of claim 14, wherein the braking system includes a hydraulic system including a master cylinder providing hydraulic pressure, and at least one valve selectively applying the baseline and increased gradients, wherein the valve includes a variable orifice defining a variable opening, corresponding to the baseline and increased gradients.

18. The vehicle of claim 14, wherein the braking system includes a hydraulic system including a master cylinder providing hydraulic pressure, wherein the master cylinder is configured to selectively apply the baseline and increased gradients.

19. The vehicle of claim 14, wherein the braking system includes an electric motor configured to selectively apply the baseline and increased gradients.

20. The vehicle of claim 14, wherein the braking system includes a regenerative braking system receiving at least a portion of a braking power from a vehicle powertrain, wherein the regenerative braking system is configured to configured to selectively apply the baseline and increased gradients via one of a friction brake torque and a powertrain regenerative torque.
